(19) United States
(12) Patent Application Publication
(10) Pub. No.: US 2025/0313120 A1
(43) Pub. Date: Oct. 9, 2025

(54) METHOD AND CHARGING SYSTEM FOR EXCHANGING AN ELECTRIC CHARGING QUANTITY BETWEEN AT LEAST ONE ELECTRIC VEHICLE AND AT LEAST ONE ENERGY SUPPLY DEVICE VIA A CHARGING DEVICE

(71) Applicant: Magna International Europe GmbH, Wien (AT)

(72) Inventors: Christian Backfrieder, St. Valentin (AT); Christian Rathberger, Linz (AT); Thomas Naderhirn, Perg (AT)

(21) Appl. No.: 18/881,598

(22) PCT Filed: Jun. 12, 2023
(86) PCT No.: PCT/EP2023/065569

§ 371 Date: Jan. 6, 2025

(30) Foreign Application Priority Data
Jul. 7, 2022 (DE) 10-2022-206-961.7

(51) Int. Cl. B60L 55/00; B60L 53/14; B60L 53/68; H02J 3/32

(52) U.S. Cl. CPC B60L 55/00; B60L 53/14; B60L 53/68; H02J 3/322

(57) ABSTRACT

A charging system and a method for exchanging an electric charging quantity between at least one electric vehicle and at least one energy supply device via a charging device. In a connection step, the electric vehicle is connected to the energy supply device in an electrically conductive manner via the charging device. In a selection step, a user of the electric vehicle is provided with an assignment selection for assigning the electric vehicle to the energy supply device. The electric charging quantity to be exchanged between the electric vehicle and the energy supply device is specified according to the assignment selection of the user of the charging device from a controller which is connected to the charging device via a communication channel. In a charging step, an electric charging quantity is exchanged between the electric vehicle and the energy supply device via the charging device.

### CROSS-REFERENCE TO RELATED APPLICATIONS

This application is a National Stage of International Application No. PCT/EP2023/065569, filed Jul. 12, 2023, which claims priority to DE 102022206961.7 filed Jul. 7, 2022. The entire disclosures of each of the above applications are incorporated herein by reference.

### FIELD OF THE INVENTION

The invention relates to a method for exchanging an amount of electrical charge between at least one electric vehicle and at least one power supply device via a charging device. The invention also relates to a charging system for exchanging an amount of electrical charge, having at least one electric vehicle, at least one power supply device and at least one charging device, such that the electric vehicle can be electrically conductively connected to the power supply device via the charging device.

### BACKGROUND OF THE INVENTION

This section provides information related to the present disclosure which is not necessarily prior art.

As a result of environmental, guideline and legislation specifications, the technical and economic pressure to align forward-looking mobility with the use of electric vehicles is constantly increasing in practice. In this case, it is necessary to take into account the technological differences between electric vehicles and vehicles operated by internal combustion engines.

For driving purposes, the electric vehicle usually has a battery as power source, which battery supplies power to an inverter and the latter then supplies power to an electric motor. As the service life progresses, the battery of the electric vehicle discharges and has to be recharged by means of an existing charging infrastructure and a charging system for further travel.

The charging infrastructures known from practice usually comprise charging devices which are arranged in a spatially distributed manner and by means of which the electric vehicle can be electrically conductively connected to a power supply device and can be recharged by the power supply device.

The circumstances in which electric vehicles known from practice require a charging infrastructure having a dense and many charging devices in order to be economical may involve disadvantages in the electrical power distribution system. This is because electrical power is usually distributed via an electrical integrated grid which electrically couples the individual electric vehicles, the charging devices and the power supply devices to one another.

Although technical concepts for charging systems are already known from practice, many questions are still unclear and require further improvement. It is therefore an object of the invention to develop the prior art to that effect and to provide both a method and a charging system by means of which a user of an electric vehicle can recharge the latter more easily and in a manner which relieves the load on the electrical charging infrastructure.

### SUMMARY OF THE INVENTION

This section provides a general summary of the disclosure, and is not a comprehensive disclosure of its full scope or all of its features.

The object is achieved according to the invention by a method as claimed in patent claim 1, wherein, in a connection step, the electric vehicle is electrically conductively connected to the power supply device via the charging device, wherein, in a subsequent selection step, an assignment selection of the electric vehicle to the power supply device is provided to a user of the electric vehicle and wherein the amount of electrical charge to be exchanged between the electric vehicle and the power supply device is specified, according to the assignment selection of the user of the charging device, by a control device which is connected to the charging device via a communication channel, and wherein, in a subsequent charging step, an amount of electrical charge is exchanged between the electric vehicle and the power supply device via the charging device.

The object is also achieved according to the invention by a charging system as claimed in patent claim 6 and which is characterized in that the charging system according to the invention can be operated by the above method.

According to the invention, a power supply device as a supplier of an electric current may be a battery store, a wind power plant, a photovoltaic installation or else another current source. In this case, the user of the electric vehicle is both (co)owner and (co)proprietor of the at least one electric vehicle and (co)owner and (co)proprietor of the at least one power supply device. Insofar as the electric vehicle may be at a distance and spaced far apart from the power supply device when the user of the electric vehicle is mobile, the central control device can set up a communication channel to all electric vehicles and power supply devices of the user and offer the user the assignment list provided in the selection step for setting the amount of electrical charge.

According to the invention, the amount of electrical charge charged to and discharged from the electric vehicle of the user is stored in a specified vehicle value in the central control device, such that the user of the electric vehicle can access their share of the amount of electrical charge irrespective of time. Optionally, they may at least partially dip into and distribute their specified vehicle value with other proprietors.

According to the assignment selection provided, the user can make a selection from power supply devices available to them, such that the electric vehicle of the user can be charged at the charging device after this selection. In this respect, the user may have a battery store in addition to the electric vehicle; the electrical power available in the battery store can be charged into their electric vehicle via the integrated grid, the charging infrastructure and the charging device after the user has made a selection. As a result, the amount of electrical charge thus drawn from the electrical integrated grid can be balanced with that from the battery store belonging to the user, such that the amount of electrical charge available to the owner of the electric vehicle and the power supply device and generated itself can be used directly and in a cost-neutral manner for charging their electric vehicle.

According to the invention, the electric vehicle of the user can also feed an amount of electrical charge, according to the assignment selection which the user has to make in the selection step, into the electrical integrated grid via the charging device, such that the power supply device can be charged according to this amount of electrical charge which is fed in. In this respect, the owner of the at least one electric vehicle and of the at least one power supply device can feed the amounts of electrical charge available to them in their electric vehicle and their power supply device themselves and irrespective of location into the electrical integrated network or draw it therefrom and/or distribute it to their electric vehicles and their power supply devices in accordance with their requirements. Accordingly, the following advantages are obtained according to the invention:
The user can use electrical power generated themselves as an owner and proprietor for charging their electric vehicle, even though the electric vehicle is not in the immediate vicinity (that is to say at the same grid node of the integrated grid) as their power supply device.
The user can accordingly achieve an increase in the internal consumption of their power supply devices (PV installations, battery stores, etc.) or other power sources available to them.
Cost savings may result from a smaller need to draw external power.

Optionally, the specified vehicle value charged by each user can be exchanged with, purchased from or sold to the co-proprietors.

According to one advantageous refinement of the invention, provision may be made for another electric vehicle to be used for the power supply device. Insofar as an electric vehicle can also always constitute a power supply device if its battery is sufficiently fully charged, it is accordingly also possible, for example, for a CO2 reduction to be brought about by a transfer of specially generated and green current into its own electric vehicle fleet. An electric vehicle which no longer requires a lot of electrical power in accordance with its intended use can share and distribute the excess electrical power after the intended use with other electric vehicles of the user via the charging device. As a result, the electric vehicles can be charged in a manner which is optimized for resource planning.

According to one particularly advantageous refinement of the invention, provision may be made for a stationary power source to be used for the power supply device. The user of the electric vehicle may be a co-owner and co-proprietor of other larger power supply devices-these could be larger photovoltaic or wind power installations or other installations in their co-ownership. To this extent, any co-proprietor of these installations can participate in and benefit from the invention. The only prerequisite is access to the jointly usable control device.

In order to keep the control device as small and mobile as possible, according to one advantageous refinement of the invention, provision may be made for a radio link to be used for the communication channel which connects the charging device and the control device, such that the at least one electric vehicle and the at least one power supply device can be spaced apart from one another at a distance. Accordingly, it is possible to dispense with a line-bound communication channel, which is sometimes difficult to use.

Optionally, the radio-connected control device may be a mobile telephone with corresponding application software; wherein it is also optionally conceivable to use a non-mobile control device and to address and control it via a web-based interface that can be reached almost from all points.

The object is also achieved according to the invention by a method for exchanging an amount of electrical charge between at least two electric vehicles and at least one power supply device via at least two charging devices as claimed in patent claim 5, wherein, in a connection step, the at least two electric vehicles are electrically conductively connected to the at least one power supply device via a respective one of the at least two charging devices, wherein, in a subsequent identification step, the vehicle is identified by a control device which is connected to the charging device via a communication channel and wherein the amount of electrical charge to be exchanged between the electric vehicle and the power supply device is specified to the charging device which is electrically conductively connected to the vehicle, according to a specified vehicle value stored in the control device, by the control device via the communication channel, and wherein, in a subsequent charging step, the amount of electrical charge is exchanged between the electric vehicle and the power supply device via the charging device.

After the user has registered and identified themselves with the central control device, the user of the electric vehicle receives credits for amounts of charge fed into the electrical integrated grid-whether by their at least one electric vehicle or by their at least one power supply device. The credits influence and increase the specified vehicle value which is stored in the central control device and assigned to the electric vehicle or to the user, wherein amounts of charge drawn from the electrical integrated grid accordingly reduce the specified vehicle value. Additional information, user settings and vehicle characteristic data which are stored in the control device, together with the specified vehicle value likewise stored in the control device, define the respective amount of electrical charge with which the charging device is intended to charge or, in the reverse case, is allowed to discharge from the electrically conductively connected electric vehicle.

In this respect, the user can select at a charging device, during each charging/discharging operation, whether they wish to draw an amount of charge from the electrical integrated grid and thus wish to reduce their specified vehicle value or, in the case of a sufficient amount of electrical charge available to the user, wish to feed it into the electrical integrated grid and thus wish to make it available to the other electric vehicles which are connected to a charging device.

As a result, a charging process according to the invention can be summarized as follows:
1. One-time registration of the user with the control device and stipulation of settings, such as for example a maximum charging time, a desired departure time or else a maximum or minimum state of charge of the battery of the electric vehicle.
2. Charging of the electric vehicle in accordance with the method according to the invention, wherein, if required, an electrical charge is supplied to the electric vehicle or else temporarily drawn, provided this has been set as such by the user.

Special billing is not required according to the invention, since no additional electrical power is supplied overall to the electrical integrated grid; this is because the amounts of electrical charge which are supplied or discharged are correspondingly balanced by the respective user and stored in the specified vehicle value in the control device.

In this respect, the electric vehicles which are connected to the charging devices can be charged and discharged at arbitrarily settable times, taking into account the amount of electrical charge connected to the integrated grid, the credited specified vehicle values of the electric vehicles and the amounts of charge fed in otherwise by the power supply devices of the users, wherein weather forecasts and other power plant capacities, which do not operate according to the method according to the invention, can also be taken into account centrally by the control device. Optionally, groups of users can also be combined and, as a community, can operate a charging system according to the invention in accordance with the method according to the invention.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an embodiment of the invention, according to an aspect of the disclosure.

### DESCRIPTION OF THE INVENTION

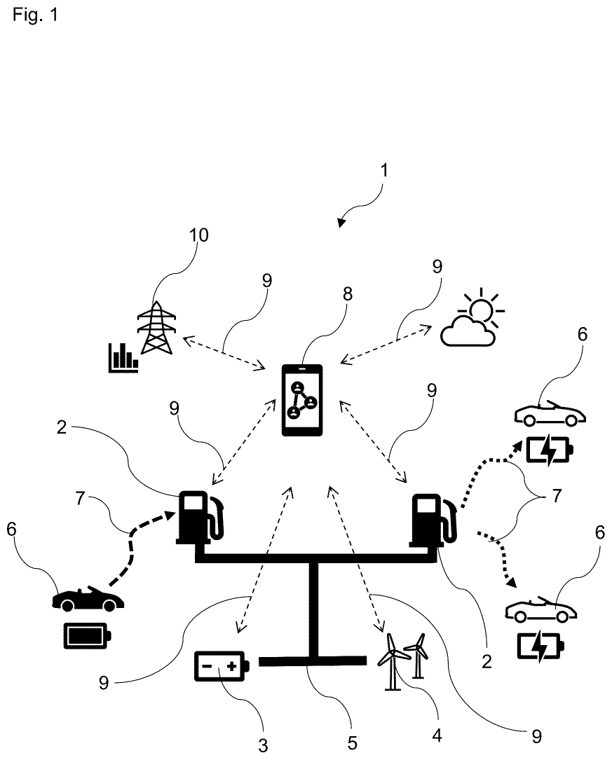

FIG. 1 comprises a schematic illustration of the invention having a central charging infrastructure 1 which has two charging devices 2, wherein the charging devices 2 are electrically conductively connected to a storage battery 3 and a wind power installation 4—in this respect, the charging infrastructure 1 represents an electrical integrated grid 5.

In the charging infrastructure 1, a total of three electric vehicles 6 are connected via electrical lines 7 to the two charging devices 2, wherein one electric vehicle 6 is shown to be sufficiently charged and two are not; in this respect, each charging device 2 can establish a communication channel 9 via a central control device 8 according to the invention and offer the user of the electric vehicle 6 an assignment selection list of the power supply devices 3, 4, 10 available to them, wherein the respective charging device 2 of the user receives from the control device 8 a specification for the amount of electrical charge to be charged into the respective electric vehicle 6, such that the respective electric vehicle 6 can be charged accordingly. However, in accordance with a state of charge of the battery, the electric vehicle 6 can also feed electrical power into the charging infrastructure 1 via the charging device 2, such that other insufficiently charged electric vehicles 6 of the user can recharge the amount of charge provided-in this respect, for the user according to the invention, the fed and drawn amounts of electrical charge of their at least one electric vehicle 6 and of their at least one power supply device 3, 4, 10 can be compensated for by a compensation calculation from the electrical integrated grid 5.

### LIST OF REFERENCE SIGNS

1. Charging infrastructure
2. Charging device
3. Storage battery
4. Wind power installation
5. Integrated grid
6. Electric vehicle
7. Electrical line
8. Control device
9. Communication channel
10. Power supply device

What is claimed is:

1. A method for exchanging an amount of electrical charge between at least one electric vehicle and at least one power supply device via a charging device, wherein, in a connection step, the electric vehicle is electrically conductively connected to the power supply device via the charging device, wherein, in a subsequent selection step, an assignment selection of the electric vehicle to the power supply device is provided to a user of the electric vehicle and wherein the amount of electrical charge to be exchanged between the electric vehicle and the power supply device is specified, according to the assignment selection of the user of the charging device, by a control device which is connected to the charging device via a communication channel, and wherein, in a subsequent charging step, the amount of electrical charge is exchanged between the electric vehicle and the power supply device via the charging device.

2. The method as claimed in claim 1, wherein another electric vehicle is used for the power supply device.

3. The method as claimed in claim 1, wherein a stationary power source is used for the power supply device.

4. The method as claimed in claim 1, wherein a radio link is used for the communication channel which connects the charging device and the control device, such that the at least one electric vehicle and the at least one power supply device can be spaced apart from one another at a distance.

5. A charging system for exchanging an amount of electrical charge, having at least one electric vehicle, at least one power supply device and at least one charging device, such that the electric vehicle can be electrically conductively connected to the power supply device via the charging device, characterized in that the charging system can be operated by a method as claimed in claim 1.

6. The method as claimed in claim 2, wherein a radio link is used for the communication channel which connects the charging device and the control device, such that the at least one electric vehicle and the at least one power supply device can be spaced apart from one another at a distance.

7. The method as claimed in claim 3, wherein a radio link is used for the communication channel which connects the charging device and the control device, such that the at least one electric vehicle and the at least one power supply device can be spaced apart from one another at a distance.
